(19) United States
(12) Patent Application Publication
(10) Pub. No.: US 2017/0123406 A1
(43) Pub. Date: May 4, 2017

(54) ADDITIVE MANUFACTURING SYSTEM AND METHOD

(71) Applicant: Caterpillar Inc., Peoria, IL (US)

(72) Inventor: Zachary S. Birky, Washington, IL (US)

(73) Assignee: Caterpillar Inc., Peoria, IL (US)

(21) Appl. No.: 14/924,762

(22) Filed: Oct. 28, 2015

(51) Int. Cl. G05B 19/4099

(52) U.S. Cl. CPC G05B 19/4099; G05B 2219/49023

(57) ABSTRACT

A method of manufacturing an object using an additive manufacturing process. The method includes determining a location on the object for a code based on an identification information for the object wherein the determined location is a part of the code and embedding a code by an additive manufacturing process at that location.

### TECHNICAL FIELD

Present disclosure relates to additive manufacturing. In particular, present disclosure relates to manufacturing objects with an identification code using additive manufacturing.

### BACKGROUND

Additive Manufacturing, also known as 3D printing, may be used to produce objects of different material, sizes and complexity. Typically, additive manufacturing involves producing an object layer by layer of a material with predetermined shape and size.

Manufacturers typically use some identification information to distinguish their products from competitors or counterfeit products. Objects being manufactured may be provided with a serial number or an identifier for identification of the part or for identifying the time, batch, manufacturing location or any other feature or property associated with the object being manufactured. The identifier may be marked on the product in the form of a logo or text or may be in the form of a code embedded with the object. Generally, the code may be put on an outer surface of the object either by embossing or printing, or on a sticker pasted on the outer surface.

Advent of additive manufacturing has made manufacturing of objects of any size and shape easy. However, additive manufacturing may also be used to produce accurate copies of an object. Using additive manufacturing, counterfeit objects may be made while copying any distinguishing mark or identification codes.

To address the counterfeiting of objects, placing the identification code at hidden locations is known in the art. For example, the identification code may be below the surface of the object or an interior surface of an object. European patent application number EP2837444 A1 discloses providing an identifier, for example a different material object, inside a closed cavity within a body of a product as a security feature. Presence of such identifier may be detected using a non-destructive technique to distinguish the genuine products from the counterfeit products. However, such objects may be copied using additive manufacturing once the location of the identifier within the object is known for the object, thus making it difficult for a user or manufacturer to distinguish a genuine product from a counterfeit product.

A user may suffer operation failure of a machine or product due to a counterfeit product. The user experience based on counterfeit products may also harm the reputation of the manufacturer. The manufacturer may also suffer financial losses on account of obligations to warranties claimed on counterfeit parts.

### SUMMARY OF THE INVENTION

In an aspect of the present disclosure, a method of manufacturing an object using an additive manufacturing process is disclosed. The method includes determining a location on the object for a code based on an identification information for the object wherein the determined location is a part of the code and embedding a code by an additive manufacturing process at that location.

In yet another aspect of the present disclosure, an object having a code is disclosed. The code is formed by an additive manufacturing process at a location within the object. The location being part of the code. Further, the location of the code is determined based on an identification information of the object.

In yet another aspect of the present disclosure, an additive manufacturing system for manufacturing an object is disclosed. The additive manufacturing system has a location generator and a machine. The location generator selects a location from a set of locations based on an identification information of the object wherein the selected location is a part of the code. The machine manufactures the object and embeds a code in the object at the selected location by an additive manufacturing process.

### BRIEF DESCRIPTION OF THE DRAWINGS

FIG. 1 illustrates an additive manufacturing system in accordance with an embodiment.

FIG. 2 illustrates a first object manufactured using additive manufacturing system in accordance with an embodiment.

FIG. 3 illustrates a similar object manufactured using additive manufacturing system in accordance with another embodiment.

FIG. 4 illustrates a similar object manufactured using additive manufacturing system in accordance with yet another embodiment, having a different orientation of the code.

FIG. 5 illustrates a similar object manufactured using additive manufacturing system in accordance with yet another embodiment, having an external code on the object.

FIG. 6 illustrates a method of manufacturing an object using additive manufacturing process in accordance with an embodiment.

### DETAILED DESCRIPTION

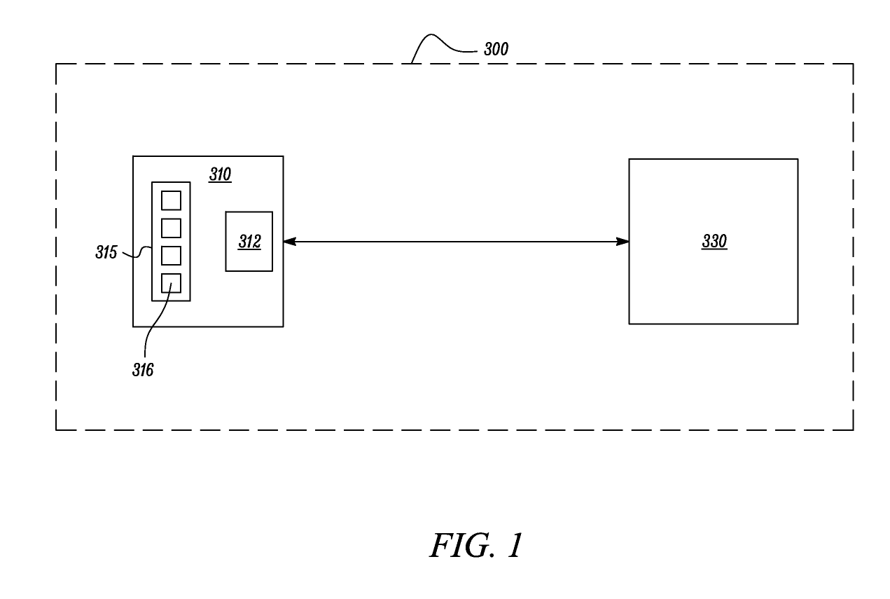

As illustrated in FIG. 1, present disclosure provides for an additive manufacturing system 300 (hereinafter referred to as AMS). The AMS 300 may include a location generator 310, a database 316, and a machine 330. The location generator 310 and the machine 330 are configured to communicate with each other. The database 316 may be stored on a memory 315. A manufacturer may manufacture multiple copies of an object 100 using the additive manufacturing system 300. The object 100 may be any product or a component of a product or packaging of a product, etc. The machine 330 may be any additive manufacturing machine or a 3D printing machine that may manufacture the object 100 using additive manufacturing process.

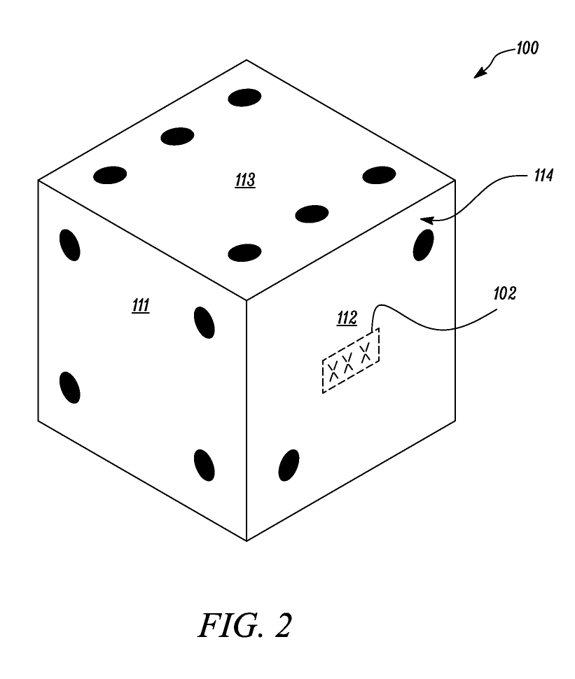

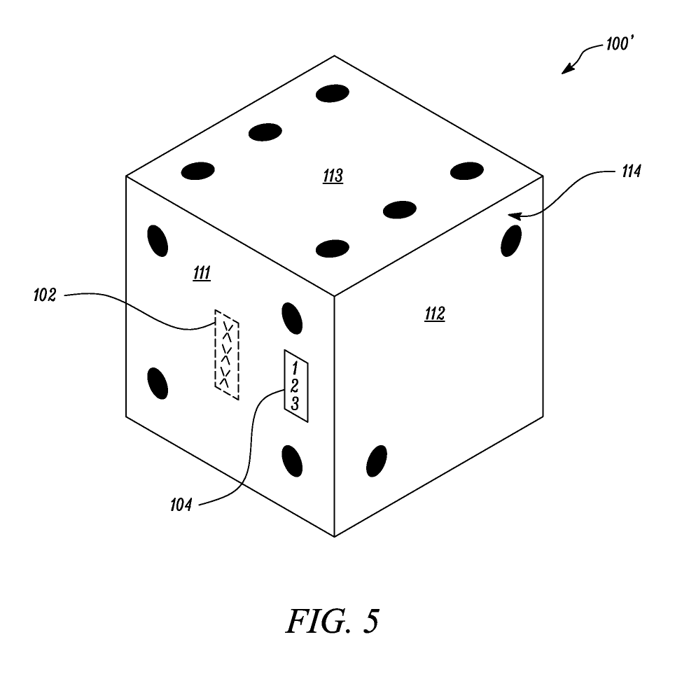

Referring also to FIG. 2, to identify individual objects 100 and to distinguish manufacturer's objects from counterfeit objects, the manufacturer may put a code 102 on the object 100 using the AMS 300. The location of the code 102 is based on any identification information associated with the object 100, for example, time of manufacturing, date of manufacturing, batch number, serial number, version number, etc. Further, the code 102 may be in any form. For example, the code 102 may be letters, numbers, symbols, logos, cavities, different density of material, different material, etc. or any combination thereof. In an embodiment, the code 102 may be placed within the object 100 such that it is not visible on a visual inspection of the object 100. In alternate embodiments, external identification information 104 for an object 100′ may be provided on an external surface of the object 100′ in addition to the code 102 placed within the object 100′ as shown in FIG. 5.

With reference to FIG. 1 and FIG. 2, the location generator 310 is configured to determine a location for embedding the code 102 on the object 100. The location generator 310 may be configured to select a location from a set of locations on the object 100 for embedding the code 102. The set of locations may include locations that are not functionally critical for the object 100. In an embodiment, code 102 may be placed on a portion of the object 100 such that it does not alter the operation of the object 100 or user experience of the object 100.

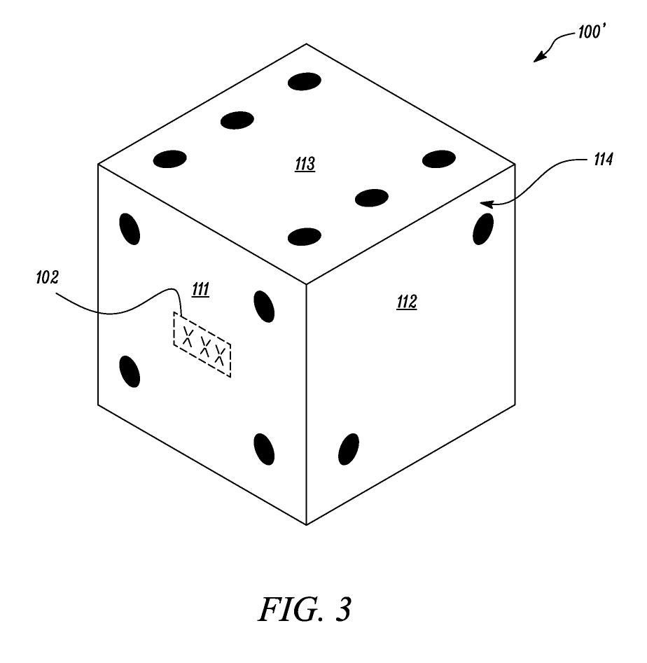

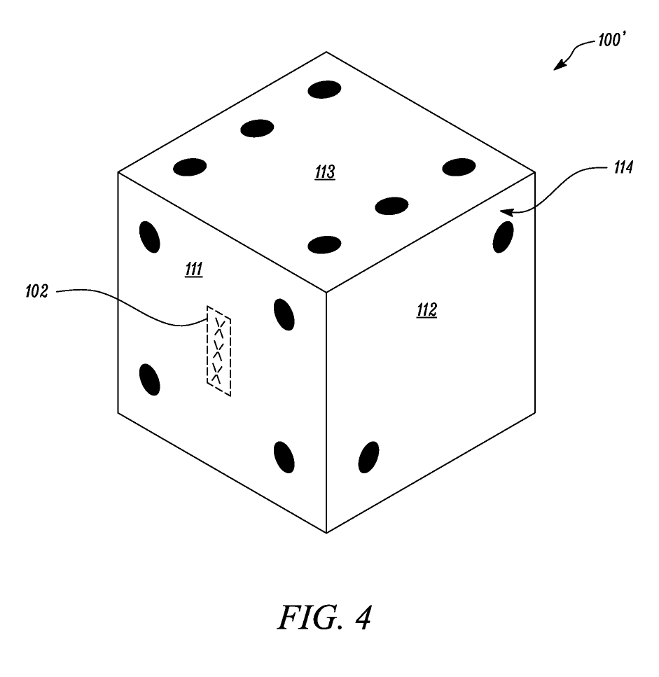

The set of locations includes specific location co-ordinates for the code 102 on the object 100. In an alternate embodiment, the location of the code 102 within the object 100′ is part of the code 102 such that different copies of the same object 100′ may have the code 102 embedded at different locations or different orientations or both. FIG. 3 and FIG. 4 illustrate the code 102 being embedded in the object 100′ at different orientations.

The selection of location may be made randomly based on the identification information associated with the object 100. The determination of the location of the code 102 may be made based on any property or feature associated with the object 100, for example time of manufacturing, the batch number of the product, version number, etc. In an embodiment, a computer software may be used to determine location of the code 102 for each object 100. In other embodiments, a computer software such as a random generator may be used to randomly determine location of the code 102 for each object. This way the location of the code 102 may not be predictable even though linked to the identification information of the object 100.

The memory 315 may store a set of locations and a set of instructions or a program. The program may be configured to select one of the locations from the set of locations for placing the code 102 on the object 100. The memory 315 may further store a set of codes 102 that may be embedded on the object 100. Further, the memory 315 may be configured to store additional information, data, content, applications, instructions, or the like. The memory 315 may include, for example, one or more volatile and/or non-volatile memories. In other words, for example, the memory 315 may be an electronic storage device (e.g., a computer readable storage medium) comprising gates configured to store data (e.g., bits) that may be retrievable by a machine (e.g., a computing device like the processor).

In an embodiment, the location generator 310 may include a processor 312. The processor 312 (and/or co-processors or any other processing circuitry assisting or otherwise associated with the processor 312) may be in communication with the memory 315. The processor 312 may be embodied in a number of different ways. For example, the processor 312 may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like.

The database 316 is configured for storing the code 102 along with the location of the code 102 along with the identification information for each object 100 being manufactured. In alternate embodiments, the location of a group of objects 100, such as a batch, may be stored in the database 316. The database 316 may be configured to be queried or searched for matching the code 102 and its location with the identification information for each object 100 manufactured using AMS 300. The database 316 may be maintained and kept confidential by the manufacturer.

In an embodiment, the location of the code 102 may be based on the type of code 102 and the identification information for the object. For some codes 102, such as different material or material density, the location of the code may be suitably chosen based on the identification information for the object.

With reference to FIG. 2 and FIG. 3, multiple copies of objects manufactured using the AMS 300 are illustrated as an exemplary embodiment. FIG. 2 illustrates the object 100 manufactured with a first identification information and FIG. 3 illustrates the object 100′ manufactured with a second identification information. The first identification information and the second identification information may be the first and second production batches of the object 100.

In the embodiment illustrated, the object 100 is a dice. In an alternate embodiment, the object 100 may be any other object of any shape, size or material. The object 100 defines an outer surface 114 and has a first portion 111, a second portion 112 and a third portion 113.

The code 102 may be located under the outer surface 114 at either the first portion 111, the second portion 112 or the third portion 113. In other embodiments, the code 102 may be located on any other portion or a part or combinations of the first portion 111, second portion 112 and third portion 113. For the object 100 illustrated in FIG. 2, the code 102 is embedded on the second portion 112. For the object 100′ illustrated in FIG. 3, the code is embedded on the first portion 111.

Manufacturing a component or an object 100 in accordance with the present disclosure may make producing counterfeit objects difficult. Any object 100 portrayed as a genuine may be tested for its genuineness by matching the code 102, including the location of the code 102, with the code 102 and its location stored in a database 316 accessible to manufacturer.

### INDUSTRIAL APPLICABILITY

Additive manufacturing has made manufacturing of objects of any size and shape easy. However, additive manufacturing may also be used to produce accurate copies of an object. Using additive manufacturing, counterfeit objects may be made while copying any distinguishing mark or identification codes.

Using these counterfeit products, the users may suffer loss due to failure in operation of a machine or product. Manufacturer may suffer financial losses in obliging to warranties claimed on counterfeit parts, also, the user experience based on counterfeit products may harm the brand image of the manufacturer, which is undesirable.

In an aspect of the present disclosure, using additive manufacturing system 300, codes 102 may be put during manufacturing at locations on the object 100 that may be hidden once the manufacturing process of the object 100 is complete. For instance, the code 102 may be below the surface of the object 100 or an interior surface of an object 100. The location of the code 102 is based on the identification information for the object 100 and thus for the same object produced in different batches, the location of the code may change. This helps in identifying original products and prevents duplication of products and also eliminates the probability of the user being conned by counterfeit products.

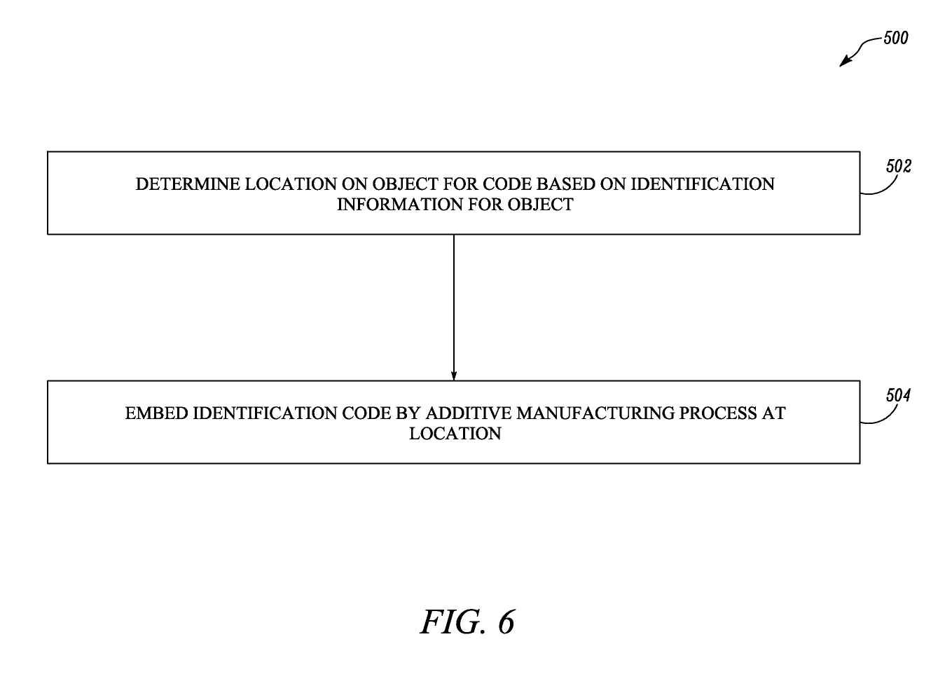

In yet another aspect of the present disclosure, a method 500 of manufacturing the object 100 using additive manufacturing is provided, as shown in FIG. 6. The step 502, includes determining location on the component for the code 102 based on an identification information for the component. The location for the code 102 may be determined randomly or based on any property or feature associated with the object 100, for example time of manufacturing or the batch number of the product. In an embodiment, a computer software may be used to determine location of the code 102 on each object 100.

Step 504 includes embedding code 102 using additive manufacturing process at the location. Once the location of the code 102 within the object 100 is determined, the code 102 may be embedded in the object 100 during manufacturing of the object 100 using additive manufacturing process.

Using the AMS 300 and method 500 in accordance with present disclosure, a manufacturer may tackle the problem of counterfeit products by being able to verify the object 100 using the code 102 that includes location of the code 102 as a part of the code 102. On producing of any object 100 as a genuine object, the manufacturer may verify the object 100 by matching the code 102 and the location of the code 102 from the database 316 that stores the location and code 102 for objects 100 manufactured by the manufacturer. Although producing an object layer by layer is contemplated, other additive manufacturing processes known to one skilled in the art would also apply.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of manufacturing an object using an additive manufacturing process comprising:
determining a location on the object for a code based on an identification information for the object; the determined location being a part of the code; and
embedding the code by the additive manufacturing process at the determined location.

2. The method as claimed in claim 1 further comprising determining the location on the object for a code based on the type of code and the identification information for the object.

3. The method of claim 1 wherein determining a location comprises determining an orientation of the code.

4. The method of claim 1 wherein determining a location for a code is randomly based on the identification information for the object.

5. The method of claim 1, further comprising storing the location of the code and the identification information of the object in a database.

6. The method of claim 1, wherein the identification information is a date of manufacture of the object.

7. The method of claim 1, wherein the identification information is a serial number of the object.

8. The method of claim 1, wherein the location is below a surface of the object.

9. The method of claim 8, further comprising providing the identification information on the surface of the object.

10. The method of claim 1, wherein the code is a different material at the location than the material of the object or a different density of the material at the location than the density of the material of the object.

11. The method of claim 1, wherein the code is a cavity formed at the location.

12. An object comprising:
a code formed by an additive manufacturing process at a location within the object; the location being a part of the code and determined based on an identification information of the object.

13. The object of claim 12, wherein the identification information is a date of manufacture of the object.

14. The object of claim 12 wherein the location of the code and the identification information of the object are stored in a database.

15. The object of claim 12, wherein the identification information is a serial number of the object.

16. The object of claim 12, wherein the location is below a surface of the object.

17. The object of claim 12, wherein the code is a different material at the location than the material of the object or a different density of the material at the location than the density of the material of the object.

18. The object of claim 12, wherein the code is a cavity formed at the location.

19. An additive manufacturing system for manufacturing an object comprising:
a location generator for selecting a location for a code from a set of locations based on an identification information of the object, the selected location being a part of the code; and
a machine for manufacturing the object and embedding a code in the object at the selected location by an additive manufacturing process.

20. The additive manufacturing system of claim 19, further comprising a database for storing the location along with the identification information of the object.
